(19) United States
(12) Patent Application Publication
(10) Pub. No.: US 2016/0025115 A1
(43) Pub. Date: Jan. 28, 2016

(54) SELF CONTAINED AND WEIGHT ENHANCED HYDROELECTRIC GENERATOR RESERVOIR

(71) Applicant: Mahad Ali, Maple (CA)

(72) Inventor: Mahad Ali, Maple (CA)

(21) Appl. No.: 14/339,384

(22) Filed: Jul. 23, 2014

(51) Int. Cl. F15B 15/06

(52) U.S. Cl. CPC F15B 15/061

(57) ABSTRACT

A portable self contained hydroelectric generator requires a reservoir of liquid to operate. This invention pertains to a self contained reservoir which uses earth's gravitational force to pressurize the contained liquid. This is achieved by placing a downward force using a weighted platform situated above the liquid. This in turn will provide an increased liquid flow to be used for hydroelectric power generation when said liquid is passed through a turbine. The flowing liquid will be collected in a second reservoir for reuse.

### CROSS-REFERENCE TO RELATED APPLICATIONS

The following is a tabulation of some prior art that presently appears relevant

U.S. Pat. Nos.

| Pat. No. | Kind Code | Issue Date | Patentee |
|---|---|---|---|
| 6,817,180 | B2 | Nov. 16, 2004 | Edwin Newman |
| 20120207588 | A1 | Aug. 16, 2012 | Aaron M. Schmidt |
| 7,222,487 | B1 | May 29, 2007 | William G. Hinkley |
| 4,345,160 | A | Aug. 17, 1982 | J. T. Smith |
| 4,965,998 | A | Oct. 30, 1990 | Filemon E. Estigoy, |
| | | | George Spector |
| 6,051,892 | A | Apr. 18, 2000 | Timothy Michael Toal, Sr. |

None of these prior art references describe the present invention.

### BACKGROUND OF THE INVENTION

1. Field of the Invention

The present invention relates to the increase of pressure for liquid substances contained within an enclosure using the gravitational force exerted on a weighted platform bearing down on said liquid. The increase in pressure results in an increase of pound-force per square inch (PSI) for the contained liquid. This increased pound-force per square inch (PSI) can be used to rotate a turbine in order to generate usable energy.

2. Description of the Related Art

Prior art teaches us to generate energy using flowing liquids by passing the liquid through a small enclosure leading to a turbine which rotates based on the flow pressure of said liquid. The pressure of the passing liquid is constant based on ambient atmospheric properties.

The current methods of generating energy using flowing liquids entail either building a dam, having a continually running stream of liquid such as a river or directly expending energy to pressurize the liquid before making use of the properties of that pressurized liquid.

### SUMMARY OF THE INVENTION

Present invention will be used to harness gravitational force for pressurizing a contained liquid using a system of weights. The weights will bear down on the liquid in order to increase the pound-force per square inch (PSI) of said liquid. This increased pound-force per square inch (PSI) will be used to operate a turbine thereby converting the force of the passing liquid into usable energy. This energy will in turn be used directly or attached to a generator to produce electrical energy for storage.

The harnessing of gravitational force through weights will be ecologically friendly and provide an alternative source of energy. Since gravitational force is available at all times of the day it is not limited in scope when compared to solar and wind energy. The invention will also be more ecologically friendly than a dam since currently dams require a running stream of liquid and that liquid is not reused once it has passed through the dam.

The accompanying drawings are included to provide a further understanding of the invention. The drawings illustrate embodiments of the invention and, together with the description, serve to explain the principles of the invention.

### BRIEF DESCRIPTION OF DRAWINGS

FIG. 1 Is a full schematic view of the invention

FIG. 2 Illustrates the portion that holds the liquid to be pressurized under weighted plates and one possible configuration of said weights

FIG. 3 Illustrates the turbine that will be used to convert the passing pressurized liquid into energy.

FIG. 4 Illustrates the container that collects the liquid once it has passed through the turbine illustrated in FIG. 3. This container is the same as FIG. 2 and will be used in the same way once the liquid is collected.

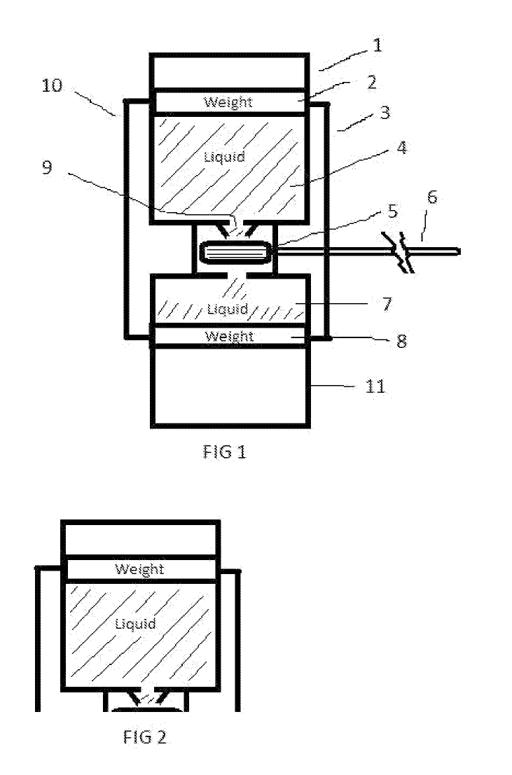

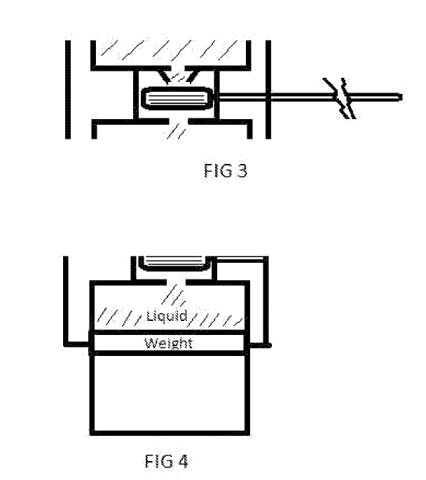

### DETAILED DESCRIPTION

The aim of the present invention is to provide a method to pressurize a contained quantity of liquid (4), within a container (1), using the earth's gravitational pull acting upon a set of weights (2,8).

Pressurizing the contained liquid aims to achieve a method to produce energy using the gravitational force on weighted plates bearing downward on the given contained liquid (2).

This increased force will increase the pound-force per square inch (PSI) for the contained liquid. This will produce an increased flow rate when the liquid is allowed to flow through a turbine (5).

The liquid container consists of a non permeable container to hold said liquid (1), an exit point which will allow the liquid to flow out (9) and a weighted platform (2) above said liquid to exert the downward force that will pressurize the liquid.

The weighted plates will be placed such that a downward force will be applied to the contained liquid. These weighted plates can be either on top of the liquid (2) or a system of pulleys (3,10) can be used to exert the force downward using a plated platform situated above the liquid.

The opening of the container (9) will be connected to a turbine (5) which will operate based on the force of the liquid passing through the opening.

The liquid will be collected within an empty container (11) in order to be reused.

The rotating turbine (5) will be used to generate electrical energy for direct use or storage.

1. A method to pressurize a contained liquid, comprising:
1) A container that holds the liquid to be pressurized
a. Said Container has a nozzle which allows liquid to escape
2) A platform positioned above the liquid which applies a downward force on said liquid, comprising:
a. A platform that itself can be used as the weight, have a weight placed on top, or have a system of weights and pulleys that apply a downward force on said platform.
